(19) United States
(12) Patent Application Publication
(10) Pub. No.: US 2005/0161630 A1
(43) Pub. Date: Jul. 28, 2005

(54) Left handed materials using magnetic composites

(76) Inventors: Siu-Tat Chui, Newark, DE (US); John Q. Xiao, Newark, DE (US)

Correspondence Address: Richard S Roberts;Roberts & Mercanti, PO Box 484, Princeton, NJ, 08542-0484, US

(21) Appl. No.: 10/504,358

(22) PCT Filed: Feb. 27, 2003
(86) PCT No.: PCT/US03/06067

Related U.S. Application Data
(60) Provisional application No. 60/361,910, filed on Feb. 28, 2002.

(51) Int. Cl. H01F 1/00

(52) U.S. Cl. 252/62.51 R; 252/62.55; 252/62.56; 252/62.54; 252/62.57; 252/62.58; 252/62.59; 252/62.6; 252/62.61; 252/62.62; 252/62.63; 252/62.64; 264/611; 264/638; 264/427

(57) ABSTRACT

A left-handed composite material which includes a mixture of a ferromagnetic material and a dielectric material. The direction of magnetization of the ferromagnetic material, and its volume fraction are controlled such that the composite material exhibits negative permeability in a frequency region near the ferromagnetic resonance frequency, and low eddy current losses. Furthermore, the handedness of the material may be locally tuned to be alternately converted into a right-handed material or a left-handed material by application of an external magnetic field, electric field, or mechanical stress. Such materials are easy to make and can be easily scaled up for industrial use.

### CROSS REFERENCE TO RELATED APPLICATION

This application claims the benefit of U.S. provisional application Ser. No. 60/361,910 filed on Feb. 28, 2002 which is incorporated herein by reference.

### GOVERNMENT INTEREST

The U.S. Government has rights in this invention pursuant to Contract Nos. ONRN00014-97-1-0300 and DAAD19-01-2-0001 between the Department of Defense (Army Research Laboratory and the Office of Naval Research) and the University of Delaware.

### BACKGROUND OF THE INVENTION

1. Field of the Invention

The present invention relates to left handed materials (LHM). More particularly, the invention relates to left-handed material composites and a process for making such composites. Such find use in the production of magnetic media and devices. Such media and devices can generate, detect, amplify, transmit, reflect, steer or otherwise control electromagnetic radiation for a variety of purposes. Such media may be changed or modulated by an externally applied magnetic field, electric field, or mechanical stress.

2. Description of the Related Art

According to conventional electrodynamics, the response of a material to electric and magnetic fields is characterized by two fundamental quantities, the permittivity ε and the permeability μ. The permittivity relates the electric displacement field \vec{D} to the electric field \vec{E} through \vec{D}=ε\vec{E}, and the permeability ε relates the magnetic field \vec{B} and \vec{H} by \vec{B}=μ\vec{H}.

Without taking losses into account and treating ε and μ as real numbers, according to Maxwell's equations, electromagnetic waves can propagate through a material only if the index of refraction n, given by (εμ)^{1/2}, is real. It should be noted that dissipation will add imaginary components to ε and μ and cause losses, but for a qualitative picture, one can ignore losses and treat ε and μ as real numbers. Also, ε and μ are second-rank tensors, but they reduce to scalars for isotropic materials.

In a medium with ε and μ both positive, the index of refraction is real and electromagnetic waves can propagate. Conventional transparent materials are examples of such kind of media. In a medium where one of ε and μ is negative but the other is positive, the index of refraction is imaginary and electromagnetic waves cannot propagate. Examples of such media include metals and Earth's ionosphere. Metals and the ionosphere have free electrons that have a natural frequency, the plasma frequency, which is on the order of 10 MHz in the ionosphere and falls at or above visible frequencies for most metals. At frequencies above the plasma frequency, ε is positive and electromagnetic waves are transmitted. For lower frequencies, ε becomes negative and the index of refraction is imaginary and consequently electromagnetic waves cannot propagate through. In fact, the electromagnetic response of metals in the visible and near ultraviolet regions is dominated by the negative epsilon concept.

Although conventional transparent materials have both positive ε and positive μ, theoretically a medium wherein ε and μ are both negative the index of refraction would also be positive, and electromagnetic waves could also propagate through them. Moreover, the propagation of waves through such a media should give rise to several peculiar properties. This was first pointed out by V. G. Veselago, Sov. Phys. Usp. 10, 509 (1968), when no material with simultaneously negative ε and μ was known. For example, the cross product of \vec{E} and \vec{H} for a plane wave in regular media gives the direction of both propagation and energy flow, and the electric field \vec{E}, the magnetic field \vec{H}, and the wave vector \vec{k} form a right-handed triplet of vectors. In contrast, in a medium with ε and μ both negative, \vec{E}×\vec{H} for a plane wave still gives the direction of energy flow, but the wave itself, that is, the phase velocity, propagates in the opposite direction, i.e., wave vector \vec{k} lies in the opposite direction of \vec{E}×\vec{H} for propagating waves. In this case, electric field \vec{E}, magnetic field \vec{H}, and wave vector \vec{k} form a left-handed triplet of vectors. Such a medium is therefore termed a “left-handed” medium.

When an electromagnetic wave travels in a normal medium having both positive permittivity and permeability, the direction of electric field \vec{E}, magnetic field \vec{H}, and wave vector k satisfy the right-hand rule, i.e., \vec{E}×\vec{H} lies along the direction of k. Hence, these materials are termed right-handed. In contrast, a material which satisfies the opposite of the right-hand rule is termed left-handed. In a left-handed material (LHM), however, \vec{E}×\vec{H} lies along the direction of −k, i.e., the wave vector is in the opposite direction of the energy flow.

Left-handed materials demonstrate many unusual physical properties which differ from those that govern the behavior of normal materials. There are a number of dramatically different propagation characteristics stemming from a simultaneous change of the signs of ε and μ, including reversal of both the Doppler shift and the Cerenkov radiation, anomalous refraction, and even reversal of radiation pressure to radiation tension. However, although these counterintuitive properties follow directly from Maxwell's equations, which still hold in these unusual materials, such left-handed materials have never been found in nature. Such media would be useful for various applications, such as in the area of radiation-material interactions. Recently, progress has been achieved in preparing a ‘left-handed’ material artificially. Following the suggestion of Pendry, et al Phys. Rev. Lett 76, 4773 (1996), Smith, et al Phys. Rev. Lett. 67, 3578 (2000) reported that a medium made up of an array of conducting nonmagnetic split ring resonators and continuous thin wires can have both an effective negative permittivity ε and negative permeability μ for electromagnetic waves propagating in some special direction and special polarization at microwave frequencies. However, the materials used in this proposed process suffer from various disadvantages, such as being difficult to make, particularly for scale up fabrication. U.S. patent application publication U.S. 2001/0038325 A1 describes other left handed composite media, however, such require an periodically arranged, ordered array of conducting elements such as wires, which together with a medium, form a negative permeability, negative permittivity composite.

It would be desirable to formulate a left-handed material which is easy to make, especially on an industrial scale, and which can be locally tuned. The present invention provides a solution to these problems. It has now been found that by incorporating metallic magnetic nanoparticles into an appropriate insulating material, and by controlling the direction of magnetization of the metallic magnetic components and their volume fraction, it is possible to prepare a composite medium of low eddy current loss, which is left-handed for electromagnetic waves propagating in a special direction, and which has polarization in a frequency region near the ferromagnetic resonance frequency. Such materials are advantageous because they are easy to make and can be easily scaled up for industrial use. More importantly, the damping loss is very small. Furthermore, the handedness of the material may be locally tuned to be alternately converted into a right-handed material or a left-handed material by application of an external magnetic field or mechanical stress.

The formation of the inventive left-handed composite materials is possible because the permittivity of metallic particles is negative at frequencies less than the plasma frequency, while the effective permeability of ferromagnetic materials for right circularly polarized (RCP) electromagnetic waves propagating parallel to the magnetization direction of the composite can be negative at frequency in the vicinity of the ferromagnetic resonance frequency ω₀, which is usually in the frequency region of microwaves. Thus, by preparing a composite medium in which one component is both metallic and ferromagnetic and other component insulating, and controlling the directions of magnetization of metallic magnetic particles and their volume fraction, it is possible to achieve a left-handed composite medium of low eddy current losses for electromagnetic waves propagating in a special direction and polarization.

### SUMMARY OF THE INVENTION

The invention provides a left handed composite material which comprises a substantially uniform mixture comprising a ferromagnetic material and a dielectric material, wherein the ferromagnetic material is present in the composite material at a volume fraction below the conductive percolation threshold of the composite; and wherein the composite material is at least partially transparent to electromagnetic radiation.

The invention also provides a method for forming a left handed composite material which comprises combining a ferromagnetic material and a dielectric material to form a substantially uniform composite material; wherein the ferromagnetic material is present in the composite material at a volume fraction below the conductive percolation threshold of the composite; and wherein the composite material is at least partially transparent to electromagnetic radiation.

The invention further provides an article which comprises a left handed composite material comprising a substantially uniform mixture comprising a ferromagnetic material and a dielectric material, wherein the ferromagnetic material is present in the composite material at a volume fraction below the conductive percolation threshold of the composite; and wherein the composite material is at least partially transparent to electromagnetic radiation.

### BRIEF DESCRIPTION OF THE DRAWINGS

FIG. 1(a) shows a graph of the frequency dependence of the real part of the effective permeability μ⁽⁺⁾ of magnetic grains for positive circularly polarized plane waves.

FIG. 1(b) shows a graph of the corresponding frequency dependences of the effective wave number k and the effective damping coefficient β in a composite consisting of metallic magnetic grains and dielectric grains.

FIG. 1(c) shows a graph of the corresponding frequency dependences of the effective wave number k and the effective damping coefficient β in a composite consisting of metallic magnetic grains and dielectric grains.

FIG. 2(a) shows a graph of the frequency dependence of the effective permeability μ⁽⁻⁾ of magnetic grains.

FIG. 2(b) shows a graph of the frequency dependencies of the effective wave number k.

FIG. 3 shows scanning electron micrographs (a)-(h) of Ni particulate loaded films.

FIG. 4 shows the amplitude (top) and phase (bottom) of the transmission spectra in external magnetic field for Ni₂₀PS₈₀ with Ni particles of about 2 μm in size, embedded in a polystyrene matrix. All data are normalized with respect to the amplitude and phase in zero field.

FIG. 5 shows the amplitude (top) and phase (bottom) of the transmission spectra in external magnetic field for (FeNi)₃₀PS₇₀ with FeNi particles of average diameter of 100 nm embedded in a polystyrene matrix. All data are normalized with respect to the amplitude and phase in zero field.

FIG. 6 shows a transmission electron micrograph of (NiFe)₃₀PS₇₀ with 30 vol. % of FeNi particles of average diameter of 100 nm embedded in polystyrene matrix.

### DETAILED DESCRIPTION OF THE PREFERRED EMBODIMENT

A left handed composite material is formed according to the invention. The left handed composite material comprises a substantially uniform mixture comprising a ferromagnetic material and a dielectric material.

Suitable ferromagnetic materials nonexclusively include iron, cobalt, nickel, ferrites, and alloys and combinations thereof. Most preferably, the ferromagnetic material comprises Fe, Ni, Co, FeNi, FeCo, FeCoNi, YIG, and/or SmCo alloys. The ferromagnetic material is preferably present in the composite material at a volume fraction below the conductive percolation threshold of the composite. This is because above the conductive percolation threshold, the composite material would become non-transparent. The ferromagnetic material is preferably present in the composite material at an amount of from about 5% to about 45% by volume of the composite material, more preferably from about 15% to about 40% by volume of the composite material, and most preferably from about 25% to about 35% by volume of the composite material.

The ferromagnetic material may be present in any suitable shape which would allow for a substantially uniform mixture of the ferromagnetic material throughout the dielectric material. The ferromagnetic material is preferably present in the form of particles, wires, rods, or plates. Preferably, the average ferromagnetic material particle size is from about 10 μm or less, more preferably from about 0.005 μm to about 1 μm, and most preferably from about 0.005 μm to about 0.5 μm. It is preferred that the ferromagnetic particles have a particle size variation which is about 20% or less compared to their average particle size.

Suitable dielectric materials nonexclusively include SiO₂, Al₂O₃, ZrO, TiO₂, Ta₂O₅ oxides, nitrides, organic and inorganic polymers, and combinations thereof. Preferably, the dielectric material comprises a material which may be polyolefins, styrenics, polyamides, polyimides, polystyrene, polycarbonates, polyurethanes, acrylonitriles, acrylics, alkoxysilane polymers, silsesquioxane polymers, siloxane polymers, poly(arylene ether), a fluorinated poly(arylene ether), polytetrafluoroethylene (PTFE), and combinations thereof.

The composite material is preferably formed by combining the ferromagnetic material and the dielectric material in a suitable manner to thereby form a substantially uniform composite material. Such combining may be conducted by any conventional means such as by shear mixing, extrusion, blending, mechanical milling, ball milling, sputtering, vacuum deposition, chemical vapor deposition, electrochemical deposition, electroless deposition, chemical synthesis, sol gel fabrication, or self assembling. Extrusion is most preferred for producing large quantity composites. High vacuum sputtering is more preferred method for fabricating thin film samples. In one embodiment, the dielectric material is mixed with ferromagnetic material particles and molded into a shaped article. In another embodiment, the dielectric material is formed into dielectric templates with pores, and the ferromagnetic material is filled inside the pores. In still another embodiment, the dielectric and ferromagnetic materials are mixed and then hot-pressed into films. In still another embodiment, the dielectric and ferromagnetic materials are mixed on to a substrate from streams of dielectric and ferromagnetic particle fluxes in vacuum.

The resulting composite material is at least partially transparent to electromagnetic radiation. Preferably, the composite material is preferably at least partially transparent to electromagnetic radiation in a frequency range of from about 10 MHz to about 10 THz. In a preferred embodiment, the composite material is preferably at least partially transparent to microwave radiation.

The following calculations based on the effective medium theory serve to illustrate the invention more clearly. A metallic magnetic granular composite is formed which includes of two types of spherical particles, one type of particles comprises metallic ferromagnetic grains of radius R₁, and the other type comprises non-magnetic dielectric (insulating) grains of radius R₂. Each grain is substantially homogeneous. The directions of magnetization of all metallic magnetic grains are assumed to be in the same direction. In length scales larger than the grain sizes, the composite can be considered as a homogeneous magnetic system. The permittivity and permeability of non-magnetic dielectric grains are both scalars, and will be denoted as ε₁ and μ₁. The permittivity of metallic magnetic grains will be denoted as ε₂ and will be taken to have a Drude form ε₂=1−ωₚ²/ω(ω+i/τ) where ωₚ is the plasma frequency of the metal and τ is a relaxation time. Such a form of ε is representative of a variety of metal composites. The permeability of metallic magnetic grains are second-rank tensors and will be denoted as \hat{μ}₂, which can be derived from the Landau-Lifschitz equations. Assuming that the directions of magnetization of all magnetic grains are in the direction of the z-axis, \hat{μ}₂ will have the following form:

$$\begin{matrix}{\hat{μ}}_{2} = [ \begin{matrix}{μ}_{a} & - i {μ}^{′} & 0 \\ i {μ}^{′} & {μ}_{a} & 0 \\ 0 & 0 & 1\end{matrix} ] where & ( 1 ) \\ {μ}_{a} = 1 + \frac{{ω}_{m} ( {ω}_{0} + ⅈ α ω )}{{( {ω}_{0} + ⅈ α ω )}^{2} - {ω}^{2}} , & ( 20 \\ {μ}^{′} = - \frac{{ω}_{m} ω}{{( {ω}_{0} + ⅈ α ω )}^{2} - {ω}^{2}} , & ( 3 )\end{matrix}$$

ω₀=γ\vec{H}₀ is the ferromagnetic resonance frequency, H₀ is the effective magnetic field in magnetic particles and may be a sum of the external magnetic field, the effective anisotropy field and the demagnetization field; ωₘ=γ\vec{M}₀, where γ is the gyromagnetic ratio, M₀ is the saturation magnetization of magnetic particles; α is the magnetic damping coefficient; ω is the frequency of incident electromagnetic waves. Only incident electromagnetic waves propagating in the direction of the magnetization are considered. The grain sizes are much smaller compared with the characteristic wavelength λ, and consequently, electromagnetic waves in the composite can be treated as propagating in a homogeneous magnetic system. According to Maxwell's equations, electromagnetic waves propagating in the direction of magnetization in a homogeneous magnetic material is either right or left circularly polarized (RCP or LCP). If the composite can truly be treated as a homogeneous magnetic system in the case of grain sizes much smaller than the characteristic wavelength, electric and magnetic fields in the composite should also be either right (superscript +) or left (superscript −) circularly polarized and can be expressed as:
\vec{E}(\vec{r},t)=\vec{E}₀^{(±)}e^{ikz-βz-iωr} (4)
\vec{H}(\vec{r},t)=\vec{H}₀^{(±)}e^{ikz-βz-iωr} (4)
where \vec{E}₀^{(±)}=\hat{x}∓iŷ, \vec{H}₀^{(±)}=\hat{x}∓iŷ, k=Real[k_{eff}] is the effective wave number, β=Im[k_{eff}] is the effective damping coefficient caused by the eddy current, k_{eff}=k+iβ is the effective propagation constant. In Equations (4)-(5) the signs of k and β can both be positive or negative depending on the directions of the wave vector and the energy flow. Assume that the direction of energy flow is in the positive direction of the z axis, i.e., β>0 in Equations (4)-(5), but the sign of k still can be positive or negative. In this case, if k>0, the phase velocity and energy flow are in the same directions, and from Maxwell's equation, the electric and magnetic field \vec{E} and \vec{H} and the wave vector \vec{k} will form a right-handed triplet of vectors. This is the usual case for right-handed materials. In contrast, if k<0, the phase velocity and energy flow are in opposite directions, and \vec{E}, \vec{H} and \vec{k} will form a left-handed triplet of vectors. This is the case for left-handed materials. Thus, for incident waves of a given frequency ω, it can be determined whether wave propagations in the composite is right-handed or left-handed through the relative sign changes of k and β. Next, the effective propagation constant k_{eff}=k+iβ shall be determined by means of the effective medium approximation. If the composite is a homogeneous magnetic system in the case of grain sizes much smaller than the characteristic wavelength, then for waves (positive or negative circularly polarized) propagating through the composite in the direction of magnetization, their propagations are described by an effective permittivity ε_{eff} and an effective permeability μ_{eff} which satisfy the following relations:

$$\begin{matrix}\int \vec{D} ( \vec{r} , ω ) {ⅇ}^{ⅈ {k}_{{eff}^{ z}}} ⅆ \vec{r} = {ɛ}_{eff} \int \vec{E} ( \vec{r} , ω ) {ⅇ}^{ⅈ {k}_{{eff}^{ z}}} ⅆ \vec{r} & ( 6 ) \\ \int \vec{B} ( \vec{r} , ω ) {ⅇ}^{ⅈ {k}_{{eff}^{ z}}} ⅆ \vec{r} = {μ}_{eff} \int \vec{h} ( \vec{r} , ω ) {ⅇ}^{ⅈ {k}_{{eff}^{ z}}} ⅆ \vec{r} & ( 7 )\end{matrix}$$

where k_{eff} and ω are related by k_{eff}=ω[ε_{eff}μ_{eff}]^{1/2}. Although these relations are simple and in principle exact, it is very difficult to calculate the integrals in them because the fields in the composite are spatially varying in a random way. Various types of approximations must therefore be used. The simplest approximation is the effective medium approximation. In this approximation, the fields in each grain are calculated as if the grain were embedded in an effective medium of dielectric constant ε_{eff} and magnetic permeability μ_{eff}. Consider, for example, the ith grain. Under the embedding assumption, the electric and magnetic fields incident on the grain are the form of Equations (4)-(5).

$$\begin{matrix}{\vec{E}}_{inc} = {\vec{E}}_{0}^{( \pm )} {ⅇ}^{ⅈ {k}_{{eff}^{- iwt}}} , & ( 8 ) \\ {\vec{h}}_{inc} = {\vec{h}}_{0}^{( \pm )} {ⅇ}^{ⅈ {k}_{{eff}^{- iwt}}} , & ( 9 )\end{matrix}$$

where \vec{E}₀^{(±)}=\hat{x}∓iŷ and \vec{h}₀^{(±)}=\hat{x}∓iŷ, corresponding to the right (+) or left (−) circularly polarized waves. If the fields inside the grain can be found, then the inside fields can be used to calculate the integral over the grain volume.

$$\begin{matrix}{\vec{I}}_{i} = {\int }_{{v}_{i}} {\vec{E}}_{i} ( \vec{r} , ω ) {ⅇ}^{ⅈ {k}_{{eff}^{ z}}} ⅆ \vec{r} , & ( 10 ) \\ {\vec{J}}_{i} = {\int }_{{v}_{i}} {\vec{h}}_{i} ( \vec{r} , ω ) {ⅇ}^{ⅈ {k}_{{eff}^{ z}}} ⅆ \vec{r} , & ( 11 )\end{matrix}$$

which is required to find the integral in Equations (6)-(7). For the right or left circularly polarized incident waves described by Esq. (8)-(9), the integral \vec{I}ᵢ, and \vec{J}ᵢ, can be written as:
\vec{I}ᵢ=(\hat{x}+iŷ)Iᵢ, (12)
\vec{J}ᵢ=(\hat{x}+iŷ)Jᵢ, (13)
where Iᵢ and Jᵢ are scalars. If Iᵢ and Jᵢ can be found, then from Equations (6)-(7), the effective permittivity ε_{eff} and effective permeability μ_{eff} can be calculated by:

$$\begin{matrix}{ɛ}_{eff} = \frac{{f}_{1} {ɛ}_{1} {I}_{1} + {f}_{2} {ɛ}_{2} {I}_{2}}{{f}_{1} {I}_{1} + {f}_{2} {I}_{2}} , & ( 14 ) \\ {μ}_{eff} = \frac{{f}_{1} {μ}_{1} {J}_{1} + {f}_{2} {μ}_{2}^{( \pm )} {J}_{2}}{{f}_{1} {J}_{2} + {f}_{2} {J}_{2}} , & ( 15 )\end{matrix}$$

where f₁ and f₂ are the volume fractions of the two types of grains, μ₁ is the permeability of non-magnetic dielectric grains, μ₂⁽⁺⁾=μ_{α}−μ′ and μ⁽⁻⁾=μ_{α}+μ′ (see Equations 1-3) are the effective permeability of magnetic grains for right and left circularly polarized waves respectively. For calculating Iᵢ and Jᵢ, one can expand interior and exterior fields in a multipole series and matching the boundary conditions. After the coefficients of the multipole expansion of interior and exterior fields are obtained by matching the boundary conditions, Iᵢ and Jᵢ can be found and subsequently be substituted into Equations (14)-(15). Such is a standard method in the art. In the final results, Equations (14)-(15) reduce to one self-consistent equation:

$${\sum }_{i = 1 , 2}^{} fi {\sum }_{i = 1}^{∞} ( 2 l + 1 ) [ \frac{{k}_{eff} {ψ}_{l}^{′} ( {k}_{i} {R}_{i} ) {ψ}_{l} ( {k}_{eff} {R}_{i} ) - {k}_{i} {ψ}_{l} ( {k}_{i} {R}_{i} ) {ψ}_{l}^{′} ( {k}_{eff} {R}_{i} )}{{k}_{eff} {ψ}_{l}^{′} ( {k}_{i} {R}_{i} ) {}_{l} ( {k}_{eff} {R}_{i} ) - {k}_{i} {ψ}_{l} ( {k}_{i} {R}_{i} ) {}_{l}^{′} ( {k}_{eff} {R}_{i} )} + \frac{{k}_{i} {ψ}_{l}^{′} ( {k}_{i} {R}_{i} ) {ψ}_{l} ( {k}_{eff} {R}_{i} ) - {k}_{eff} {ψ}_{l} ( {k}_{i} {R}_{i} ) {ψ}_{l}^{′} ( {k}_{eff} {R}_{i} )}{{k}_{i} {ψ}_{l}^{′} ( {k}_{i} {R}_{i} ) {ς}_{l} ( {k}_{eff} {R}_{i} ) - {k}_{eff} {ψ}_{l} ( {k}_{i} {R}_{i} ) {}_{l}^{′} ( {k}_{eff} {R}_{i} )} ] = 0 , \qquad ( 16 )$$

where Rᵢ is the radius of the ith type of grains, and
k₁=ω[ε₁μ₁]^{1/2}, (17)
k₂=ω[ε₂μ₂^{(±)}]^{1/2}, (18)
ψₗ(x)=xjₗ(x), (19) [symbol]
ₗ(x)=xhₗ⁽¹⁾(x), (20)
jₗ(x) and hₗ(x) are the usual spherical Bessel and Hankel functions. Equation (16) is used to determine the effective product of (εμ)_{eff}, or equivalently k_{eff}, but not a single ε_{eff} and μ_{eff}. It can be used to describe the change of the phase of a plane wave across a slab of the composite, but it does not precisely describe wave propagations across a slab of the composite. This is due to the fact that no attempt is made to rigorously solve the boundary-value problem for a slab of composite by matching the fields inside the slab and external fields outside the slab at the boundary. In fact, it is common in various types of effective medium theories that for ω≠0 the electromagnetic properties of a composite cannot in general be specified by a single ε_{eff} and μ_{eff}. Since it can be determined whether wave propagations through the composite is left-handed or right-handed by the calculation of the effective propagation constant k_{eff}, Equation (16) is sufficient.

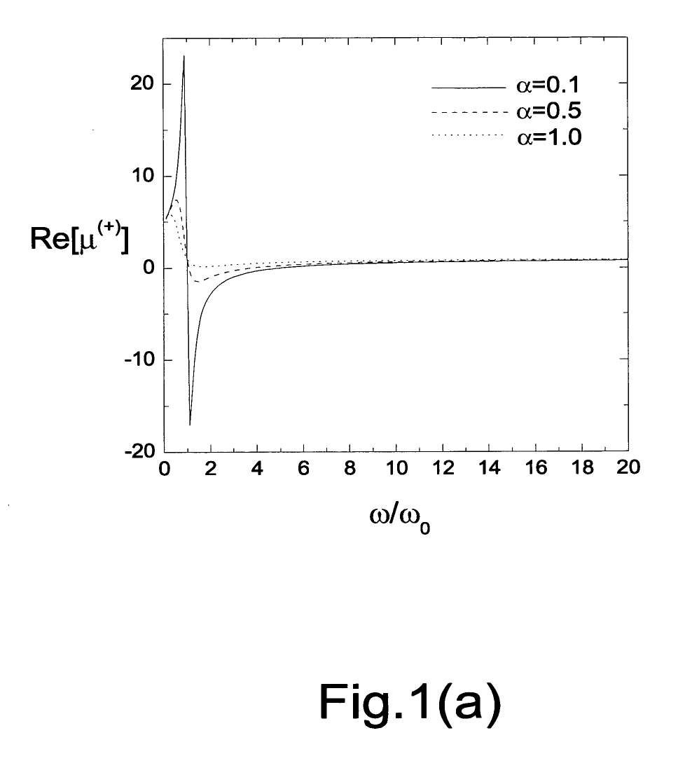

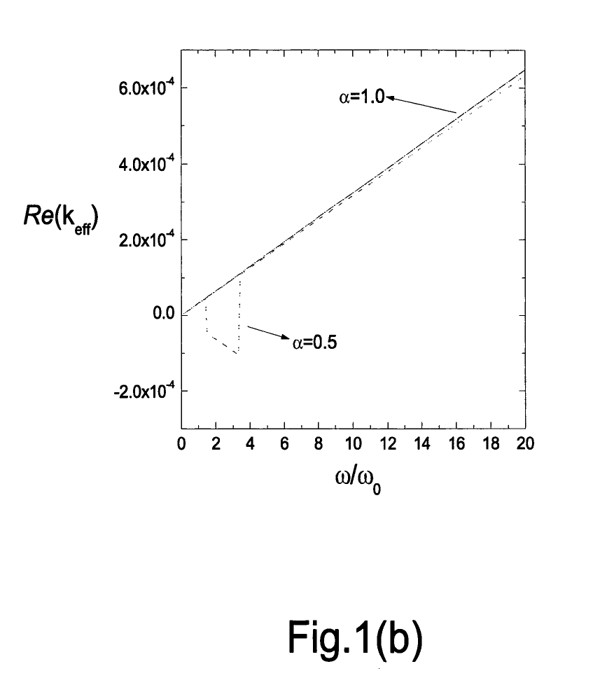

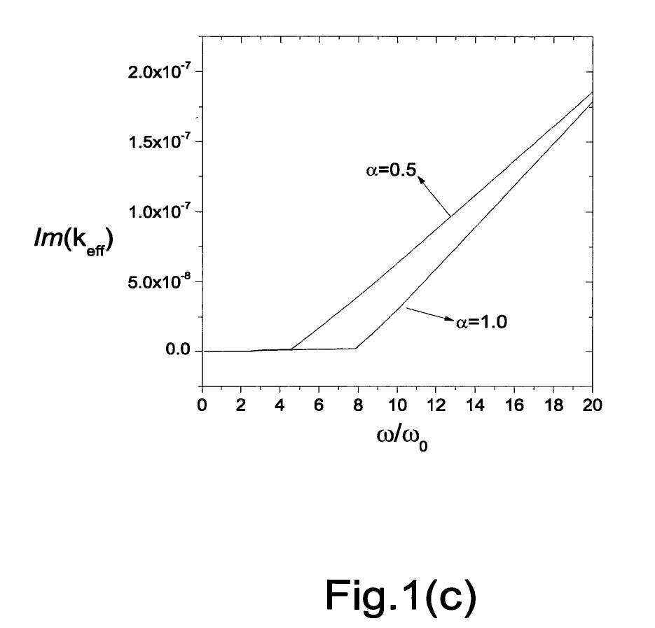

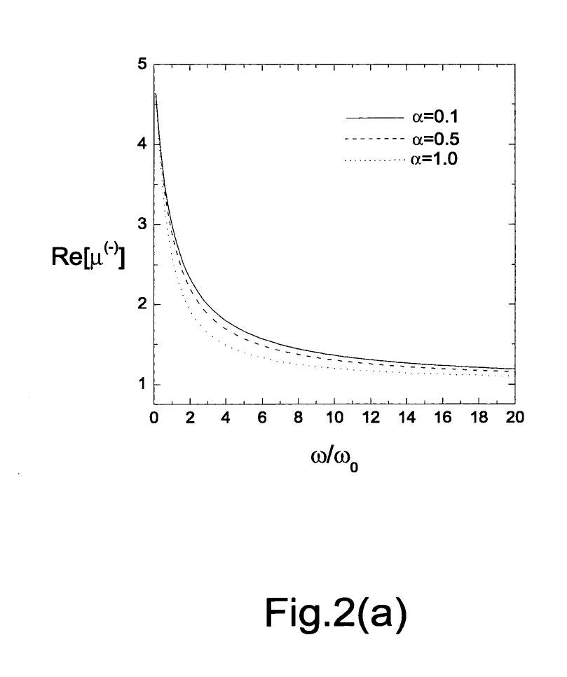

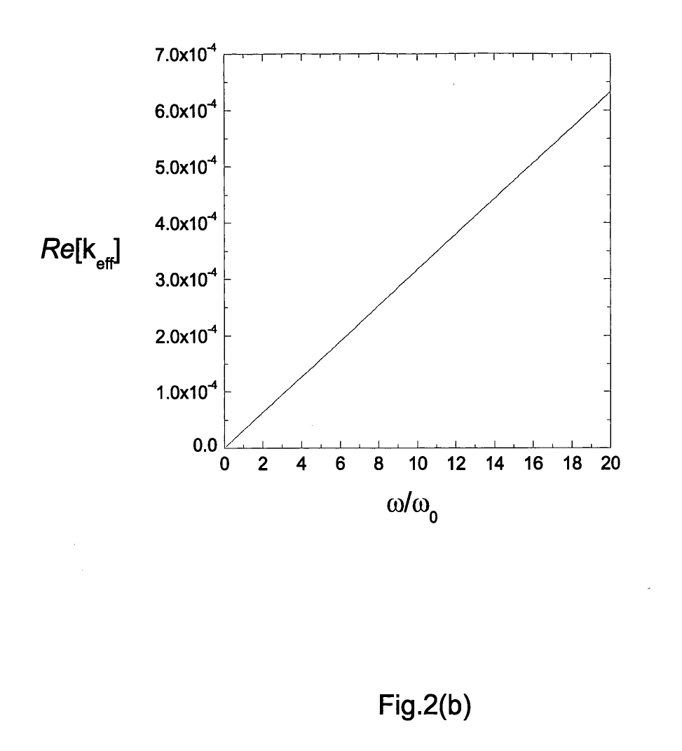

The numerical results for a metal volume fraction f₂ of 0.3 obtained from Equation (16) are summarized in FIG. 1-FIG. 2. FIG. 1(a) shows the frequency dependence of the real part of the effective permeability μ⁽⁺⁾ of magnetic grains for right circularly polarized plane waves, FIGS. 1(b) and (c) show the corresponding frequency dependences of the effective wave number k and the effective damping coefficient β in a composite consisting of metallic magnetic grains and dielectric grains. The plasma frequency ωₚ is usually in the visible or ultraviolet frequency region and the ferromagnetic resonance frequency ω₀ is usually in the microwave frequency region. For simplicity, hereafter we will set ωₒ/ωₚ=10⁻⁵. The other parameters are: ωₘ/ω₀=4.0, ωₚR/c=0.2, f₂=0.3, α is shown in the figures. From Equations (1)-(3), one can conclude that if the magnetic damping coefficient α is zero, Re[μ⁽⁺⁾] will be negative in the whole frequency region of ω>ω₀ (the magnetic resonance frequency). From FIG. 1(a), it can be concluded that if α is nonzero but small enough, there can still be a frequency region near ω₀ in which Re[μ⁽⁺⁾] is negative. In this case, if the amplitude of the negative μ⁽⁺⁾ is large enough, k will be negative in this frequency region as was shown in FIG. 1(b), and hence the phase velocity and energy flow will be in the opposite directions in this frequency region, and \vec{E}, \vec{H} and \vec{k} will form a left-handed triplet of vectors, i.e., the composite will be left-handed in this frequency region for positive circularly polarized plane waves. But if α is not small enough, Re[μ⁽⁺⁾] will be positive in the whole frequency region, or though Re[μ⁽⁺⁾] is negative in a frequency region near ω₀, the amplitude of the negative Re[μ⁽⁺⁾] is not large enough, in this case k will be positive in the whole frequency region, as was shown in FIG. 1(b). In this case, the composite is right-handed for positive circularly polarized waves in the whole frequency region. The calculations also show that if the radius of metallic grains are small enough and the volume fraction of metal components is smaller than the threshold value of the insulator-metal transition, which is approximately 1/3 in this model, the losses caused by eddy current are very small and the composite is essentially an insulator. This is shown in FIG. 1(c), in which the damping coefficient β is very small compared with the amplitude of the wave number k, i.e., the eddy current losses are very small in the cases shown in FIG. 1. If the volume fraction of metal components is larger than the threshold value, the composite will be essentially a metal, and the damping coefficient β will be much larger than the amplitude of wave number k (not shown in the figure).

FIG. 2(a) shows the frequency dependence of the real part of the effective permeability μ⁽⁻⁾ of magnetic grains for left circularly polarized waves, and FIG. 2(b) shows the corresponding frequency dependence of the effective wave number k in a composite consisting of the metallic magnetic grains and dielectric grains. Thus, for left circularly polarized waves, Re[μ⁽⁻⁾] is positive in the whole frequency region no matter how small α is, and correspondingly, k is positive in the whole frequency region, i.e., the composite is right-handed in the whole frequency region for left circularly polarized waves no matter how small α is.

The left-handed materials of the present invention exhibit the following properties:
(1) reversed Doppler effect—microwave radiation or light shift to lower frequencies as a source approaches and to higher frequency as it recedes;
(2) reversed Cerenkov effects—light emitted in the backward direction (forward direction in a right-handed material) when a charged particle passes though a medium; and
(3) reversed Snell's law—light that enters an LHM from a normal material will undergo refraction, but opposite to that usually observed.

The left-handed composite material of the invention may be formed into a shaped article. Such may be done by any conventional method such as molding, extrusion molding, or the like.

In a preferred embodiment, the composite material may be alternately converted into either right-handed composite material or a left-handed composite material by the application of a magnetic field or mechanical stress.

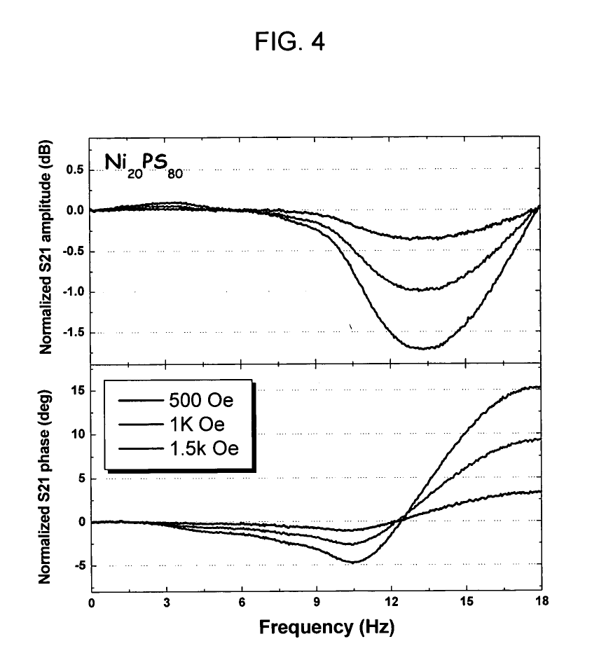

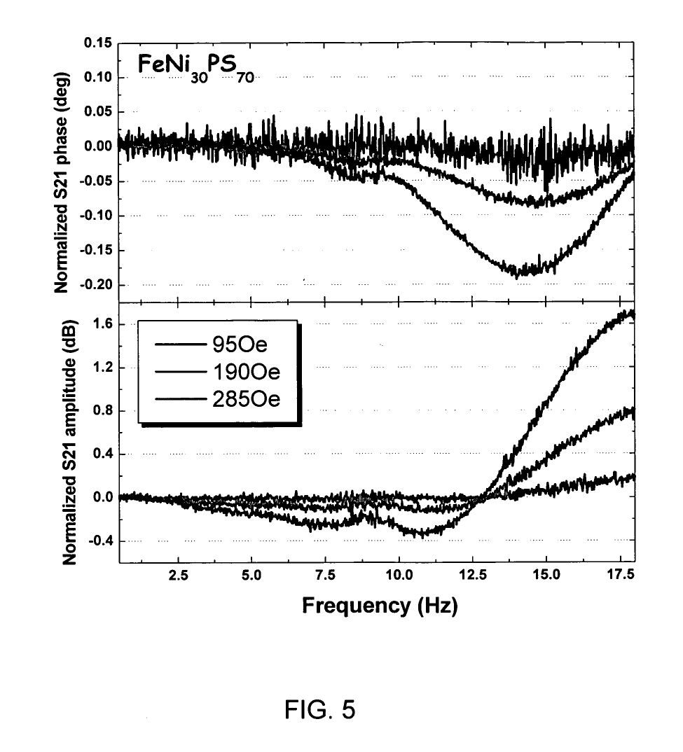

Typical transmission patterns (amplitude and phase) of left handed composites in the external magnetic field are shown in FIG. 4 and FIG. 5. The value of amplitude (top panels) and phase (bottom panels) are normalized to the amplitude and phase, respectively, in zero field.

The left-handed materials of the invention can have many uses and applications, such as electromagnetic wave (EM) signature management, phase shifters, phase array antennas, solid state antennas, filters, circulators, isolators, resonators, variable attenuators, modulators, and switches. Such left-handed materials are particularly useful for the formation of communication devices and elements. Left-handed materials can also be used to make lenses such as perfect lenses, or lenses that do not have a diffraction limit.

The following non-limiting examples serve to illustrate the invention. It will be appreciated that variations in proportions and alternatives in elements of the components of the invention will be apparent to those skilled in the art and are within the scope of the present invention.

### EXAMPLE 1

Fabrication of Co Nanoparticles:

1. Dissolve 17.5 g Co(OH)₂ into 350 ml ethylene glycol (EG) so that the concentration of [Co²⁺] is around 0.2 M;
2. Slowly heat the solution with mechanic or magnetic stirring to the boiling point of EG to distill off water and other small molecules;
3. Weight 1˜10 mg K₂PtCl₄ and dissolve them into a few mL EG, then inject the solution into above system so that the concentration of K₂PtCl₄ is 0.05˜1 mM. This will generate many tiny Pt clusters serving as nucleating center;
4. Continue heating the mixture and maintain refluxing for several hours (3-5 hrs) before cooling down the mixture to RT.

5. The precipitation is separated from the solution by using a magnet or centrifugator. The precipitates are first washed in de-ionized water for 3 to 4 times, then in alcohol and acetone for several times, and finally dried at about 50° C. in argon atmosphere. The obtained Co nanoparticles have sizes between 30 nm to 100 nm, saturation magnetization between 120, to 160 emu/g, and coercive field Hc between 200 to 300 Oe.

### EXAMPLE 2

Fabrication of CoNi Particles:

1. Dissolve 4.5 g Co(OH)₂ and 4.5 g NiCl₂ into 75 ml ethylene glycol (EG);
2. Dissolve 6 g NaOH into 75 mL EG;
3. Mix above two solutions well by vigorous stirring;
4. Slowly heat the mixture to boiling and maintain refluxing for 3-5 hrs before cooling down the mixture to room temperature.
5. The precipitation is separated from the solution by using a magnet or centrifugator. The precipitates are first washed in de-ionized water for 3 to 4 times, then in alcohol and acetone for several times, and finally dried at about 50° C. in argon atmosphere. The obtained CoNi nanoparticles have size around 1 μm, saturation magnetization between 110 to 150 emu/g, and coercive field Hc between 100 to 300 Oe.

### EXAMPLE 3

Fabrication of Co Nanoparticles:

Pour 200 ml mineral oil into the bottom of a reaction beaker; 5.384 g of CoCl₂.6H₂O is first dispersed and partly dissolved into 200 ml ethanol and then added on the top of the oil. (Oleic acid can be added to reduce the agglomeration of magnetic particles). 1.712 g of NaBH₄ is dissolved into 200 ml ethanol and then add into above solution in a drop-like manner by using a dropping funnel. A magnet under the reaction beaker is used to attract the formed magnetic particles into the oil phase. After the reaction is completed, with the help of the magnet, the supernatant solution and the oil are dismissed. The slurries are first washed by alcohol and acetone for several times to remove the residual oil, then followed by rinsing in de-ionized water for several times to thoroughly remove NaCl formed during the reaction, and finally washed by acetone again to remove water. The formed Co nanoparticles are either kept in mineral oil or a vacuum desiccator. The obtained Co nanoparticles have of 4.7 nm with standard deviation 1.6 nm, saturation magnetization between 60 to 80 emu/g, and coercive field Hc between 50 to 200 Oe.

### EXAMPLE 4

Fabrication of FeNi Particles:

Pour 200 ml mineral oil into the bottom of a reaction beaker; 17.753 g of FeCl₂.4H₂O and 21.2277 g of NiCl₂.6H₂O are first dispersed and partly dissolved into 400 ml ethanol and then added on the top of the oil. (Oleic acid can be added to reduce the agglomeration of magnetic particles). 13.516 g of NaBH₄ is dissolved into 300 ml ethanol and then add into above solution in a drop-like manner by using a dropping funnel. A magnet under the reaction beaker is used to attract the formed magnetic particles into the oil phase. After the reaction is completed, with the help of the magnet, the supernatant solution and the oil are dismissed. The slurries are first washed by alcohol and acetone for several times to remove the residual oil, then followed by rinsing in de-ionized water for several times to thoroughly remove NaCl formed during the reaction, and finally washed by acetone again to remove water. The formed FeNi nanoparticles are either kept in mineral oil or a vacuum desiccator.

### EXAMPLE 5

Fabrication of FeCo Particles:

Pour 200 ml mineral oil into the bottom of a reaction beaker; 17.321 g of FeCl₂.4H₂O and 20.729 g of CoCl₂.6H₂O are first dispersed and partly dissolved into 500 ml ethanol and then added on the top of the oil. (Oleic acid can be added to reduce the agglomeration of magnetic particles). 13.183 g of NaBH₄ is dissolved into 300 ml ethanol and then add into above solution in a drop-like manner by using a dropping funnel. A magnet under the reaction beaker is used to attract the formed magnetic particles into the oil phase. After the reaction is completed, with the help of the magnet, the supernatant solution and the oil are dismissed. The slurries are first washed by alcohol and acetone for several times to remove the residual oil, then followed by rinsing in de-ionized water for several times to thoroughly remove NaCl formed during the reaction, and finally washed by acetone again to remove water. The formed FeCo nanoparticles are either kept in mineral oil or a vacuum desiccator.

### EXAMPLE 6

Fabrication of Mₓ(Polystyrene)₁₀₀₋ₓ Composites (M: Co, FeNi, FeCo, CoNi, Ni, Fe, and Ni, x is the Volume Concentration in the Range of 0<x<50)

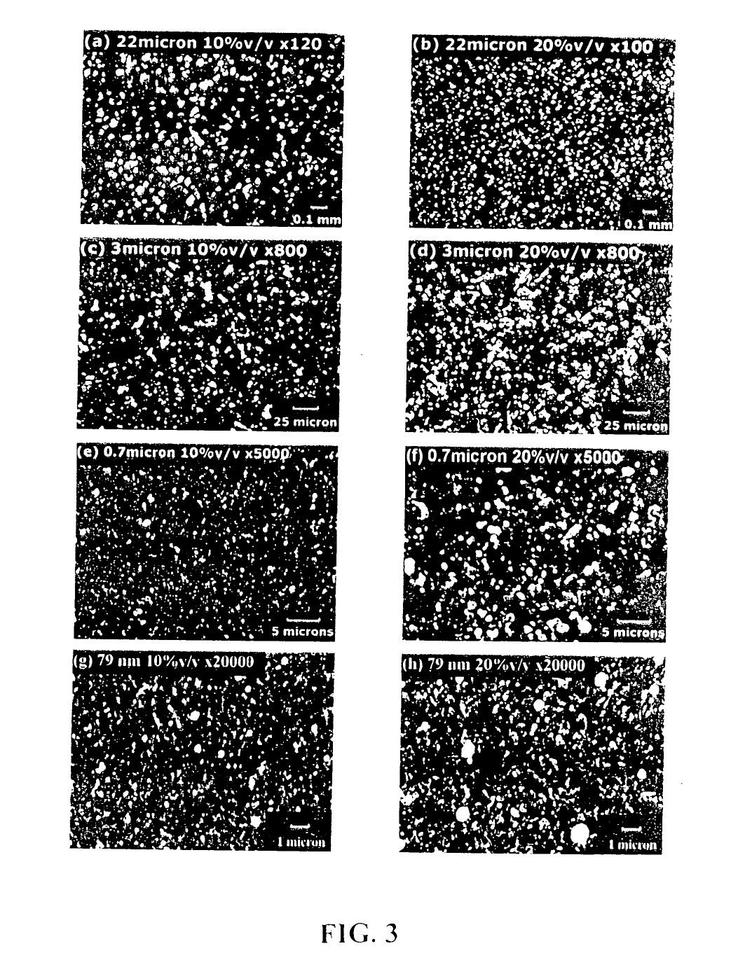

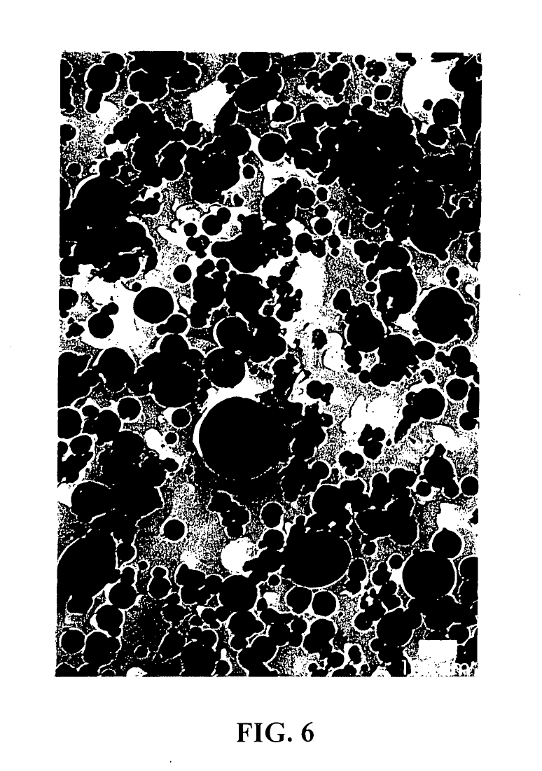

The particles prepared above are dispersed in polystyrene toluene solution and sonicated for 20-30 minutes. The amount will be determined according to the value of x. The dispersion is then put into an oven and heated to about 80° C. to allow the toluene evaporate. The raw materials will be cut into small pieces and fed into DACA twin-screw extruder. The extruder temperature is set to about 170° C. The materials are mixed between two screws along the channel of the microcompounder for about 10-20 minutes. After the extrusion, magnetic particles can be homogeneously dispersed into the polymer matrix and the materials can be hot pressed in any desirable shape. FIG. 3 shows SEM micrographs (a)-(h) of the Ni particulate loaded composite of each particle size and volume fraction. A transmission electron micrograph for FeNi loaded composite is shown in FIG. 6.

### EXAMPLE 7

Fabrication of (Fe₁₉N₈₁)₂₅(SiO₂)₇₅ Films:

A magnetron sputtering target of (Fe₁₉Ni₈₁)₂₅(SiO₂)₇₅ was used, where subscripts outside the parentheses represent volume concentration. The composite film of a nominal composition (Fe₁₉Ni₈₁)₂₅(SiO₂)₇₅ was fabricated at 4 mT Ar pressure using magnetron sputtering technique.

### EXAMPLE 8

Fabrication of Anodic Alumina Template (AAT) with Random Pores:

A 0.1 mm thick aluminum foil of 99.5 purity is first heated at 500° C. for 5 hours to reduce the internal stress and defects. The foil is then placed in a 1M NaOH solution for 1 minute to remove surface aluminum oxide. The foil is then anodized for 3 hours with a DC power supply in a solution of 0.4M H₂SO₄ at 0° C., under a potential of 25V. The AAT so obtained is about 20 μm in thickness, pore separation is about 60 nm. Different separations can be obtained with different potentials. The pores are widened in a solution of 6 wt % H₃PO₄ at 30° C. for 20 minutes, and the pore diameter is about 25 nm. Different pore diameters can be obtained by controlling the time.

### EXAMPLE 9

Fabrication of Anodic Alumina Template (AAT) with Ordered Pores:

A 1 mm thick aluminum foil of purity 99.999 is first heated at 500° C. for 24 hours to reduce the internal stress and defects. The foil is then placed in a 1M NaOH solution for 3 minutes to remove surface aluminum oxide. The foil is then anodized for 10 hours in a solution of 0.4M H₂SO₄ at 0° C., with an external potential of 25V. The foil is subsequently placed in a solution of 6 wt % H₃PO₄ and 1.8 wt % H₂CrO₄ at 60° C. for 10 hours to etch away the alumina made during the previous step. The foil is again anodized for 10 hours in a solution of 0.4M H₂SO₄ at 0° C. with an external potential of 25V. The AAT so obtained is about 20 μm in thickness, pore separation is about 60 nm. Different separation can be obtained with different potentials. The pores are widened in a solution of 6 wt % H₃PO₄ at 30° C. for 20 minutes, and the pore diameter is about 25 nm. Different pore diameters can be obtained by controlling the time.

### EXAMPLE 10

Filling the Magnetic Metals (Fe, Ni Co, FeNi, FeCo) Inside the Pore:

An anodic alumina template (AAT) is formed according to Example 2 or 3. After the fabrication of the AAT, the remaining aluminum works as a cathode. Fe, Ni, Co, FeNi or FeCo are electrodeposited into the nanopores by galvanic method from corresponding sulfate solutions. The electrolytes for Fe, Ni or Co are 0.1M FeSO₄, 0.1M NiSO₄, or 0.1M CoSO₄ respectively. 0.1M H₃BO₃ are added to the above solutions to adjust the PH values. The current density is about 10 mA/cm². For FeCo, we use FeSO₄.7H₂O 57 g/L, CoSO₄.7H₂O 79 g/L, H₃BO₃ 30 g/L, and Saccharin 2-2.7 g/L. The current density is about 15 mA/cm², and an Fe_{0.45}CO_{0.55} alloy nanowire array is obtained. For FeNi case, one applies FeSO₄.7H₂O 6 g/L, NiSO₄.7H₂O 140 g/L, H₃BO₃ 30 g/L, and Fe₁₄Ni₈₆ is obtained.

### EXAMPLE 11

A left handed composite material of the invention is formed according to Examples 1-10. The high frequency magnetic permeability of these materials is measured using a HP network analyzer with fixtures including stripline, coaxial cable, microstripline, co-planar waveguide, permeameter, and resonant cavity of 500 MHz base frequencies. Negative permeability above the ferromagnetic resonance is observed in FeNi films. FeNi particles do not show a negative permeability without a DC bias magnetic field. With an external DC bias magnetic field, the negative permeability of FeNi particles can be seen. When FeNi is mixed with various polymer matrixes, it exhibits negative permeability in FeNi based composites. Furthermore, microwave reflection and transmission measurement are performed.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. A left handed composite material which comprises a substantially uniform mixture comprising a ferromagnetic material and a dielectric material, wherein the ferromagnetic material is present in the composite material at a volume fraction below the conductive percolation threshold of the composite; and wherein the composite material is at least partially transparent to electromagnetic radiation.

2. The left handed composite material of claim 1 wherein said ferromagnetic material comprises ferromagnetic particles, wires, rods, or plates.

3. The left handed composite material of claim 1 wherein said ferromagnetic material comprises ferromagnetic particles.

4. The left handed composite material of claim 3 wherein the ferromagnetic particles have an average particle size of about 10 μm or less.

5. The left handed composite material of claim 3, wherein the ferromagnetic particles have a particle size variation which is about 20% or less compared to their average particle size.

6. The left handed composite material of claim 1, wherein the ferromagnetic material is present in the composite material at an amount of from about 5% to about 40% by volume of the composite material.

7. The left handed composite material of claim 1, wherein the ferromagnetic material is selected from the group consisting of iron, cobalt, nickel, ferrites, and alloys and combinations thereof.

8. The left handed composite material of claim 1, wherein the ferromagnetic material comprises Fe, Ni, Co, FeNi, FeCo, FeNiCo, SmCo or combinations thereof.

9. The left handed composite material of claim 1, wherein the dielectric material comprises a material selected from the group consisting of SiO₂, Al₂O₃, Ta₂O₅, oxides, nitrides, organic and inorganic polymers, and combinations thereof.

10. The left handed composite material of claim 1, wherein the dielectric material comprises a material selected from the group consisting of polyolefins, styrenics, polyamides, polyimides, polystyrene, polycarbonates, polyurethanes, acrylonitriles, acrylics, alkoxysilane polymers, silsesquioxane polymers, siloxane polymers, poly(arylene ether), a fluorinated poly(arylene ether), polytetrafluoroethylene, and combinations thereof.

11. The left handed composite material of claim 1, wherein the dielectric material comprises SiO₂.

12. The left handed composite material of claim 1 wherein the composite is at least partially transparent to electromagnetic radiation in a frequency range of from about 10 MHz to about 10 THz.

13. The left handed composite material of claim 1 wherein the composite is at least partially transparent to microwave radiation.

14. The left handed composite material of claim 1, wherein the composite material is capable of being alternately converted into either a right-handed material or a left-handed material by application of an external magnetic field or mechanical stress.

15. A method for forming a left handed composite material which comprises combining a ferromagnetic material and a dielectric material to form a substantially uniform composite material; wherein the ferromagnetic material is present in the composite material at a volume fraction below the conductive percolation threshold of the composite; and wherein the composite material is at least partially transparent to electromagnetic radiation.

16. The method of claim 15, wherein the combining is conducted by shear mixing, extrusion, blending, mechanical milling, ball milling, sputtering, vacuum deposition, chemical vapor deposition, electrochemical deposition, electroless deposition, chemical synthesis, sol gel fabrication, or self assembling.

17. The method of claim 15 further comprising the subsequent step of forming the composite material into a shaped article.

18. The method of claim 17 wherein the shaped article is formed by molding or extrusion molding.

19. The method of claim 15, further comprising the step of alternately converting the composite material into either right-handed composite material or a left-handed composite material by the application of a magnetic field or mechanical stress.

20. The method of claim 15 wherein said ferromagnetic material comprises ferromagnetic particles, wires, rods, or plates.

21. The method of claim 15 wherein said ferromagnetic material comprises ferromagnetic particles.

22. The method of claim 21 wherein the ferromagnetic particles have an average particle size of about 10 μm or less.

23. The method of claim 21, wherein the ferromagnetic particles have a particle size variation which is about 20% or less compared to their average particle size.

24. The method of claim 15, wherein the ferromagnetic material is present in the composite material at an amount of from about 5% to about 40% by volume of the composite material.

25. The method of claim 15, wherein the ferromagnetic material is selected from the group consisting of iron, cobalt, nickel, ferrites, and alloys and combinations thereof.

26. The method of claim 15, wherein the ferromagnetic material comprises Fe, Ni, Co, FeNi, FeCo, FeNiCo, and/or SmCo.

27. The method of claim 15, wherein the dielectric material comprises a material selected from the group consisting of SiO₂, Al₂O₃, Ta₂O₅, oxides, nitrides, organic and inorganic polymers, and combinations thereof.

28. The method of claim 15, wherein the dielectric material comprises a material selected from the group consisting of polyolefins, styrenics, polyamides, polystyrene, polyimides, polycarbonates, polyurethanes, acrylonitriles, acrylics, alkoxysilane polymers, silsesquioxane polymers, siloxane polymers, poly(arylene ether), a fluorinated poly(arylene ether), polytetrafluoroethylene, and combinations thereof.

29. The method of claim 15, wherein the dielectric material comprises SiO₂.

30. The method of claim 15 wherein the composite is at least partially transparent to electromagnetic radiation in a frequency range of from about 10 MHz to about 10 THz.

31. The method of claim 15 wherein the composite is at least partially transparent to microwave radiation.

32. An article which comprises a left handed composite material comprising a substantially uniform mixture comprising a ferromagnetic material and a dielectric material, wherein the ferromagnetic material is present in the composite material at a volume fraction below the conductive percolation threshold of the composite; and wherein the composite material is at least partially transparent to electromagnetic radiation.
